(19) United States
(12) Patent Application Publication
(10) Pub. No.: US 2025/0157051 A1
(43) Pub. Date: May 15, 2025

(54) INFORMATION PROCESSING DEVICE AND INFORMATION PROCESSING METHOD

(71) Applicant: SONY GROUP CORPORATION, TOKYO (JP)

(72) Inventor: TSUYOSHI ISHIKAWA, TOKYO (JP)

(21) Appl. No.: 18/837,648

(22) PCT Filed: Feb. 2, 2023
(86) PCT No.: PCT/JP2023/003345

§ 371 Date: Aug. 12, 2024

(30) Foreign Application Priority Data
Feb. 18, 2022 (JP) 2022-023415

(51) Int. Cl. G06T 7/246; G06T 7/70; G06T 17/00

(52) U.S. Cl. CPC G06T 7/246; G06T 7/70; G06T 17/00

(57) ABSTRACT

The present technology relates to an information processing device and an information processing method that enable easy recognition and tracking of a portion where a real object acts on its surroundings.

The information processing device includes a recognition unit that recognizes a relative position of an acting portion relative to a marker fixed to a target object, the acting portion corresponding to a portion of the target object used by a user to act on surroundings in a virtual world or a real world, and a tracking unit that tracks the acting portion on the basis of the relative position of the acting portion relative to the marker. The present technology is applicable to augmented reality (AR) glasses, for example.

### TECHNICAL FIELD

The present technology relates to an information processing device and an information processing method, and more particularly, to an information processing device and an information processing method suitable for use in a case of recognizing and tracking a portion where a real object acts on its surroundings.

### BACKGROUND ART

There has been proposed a configuration where the use of a specifically-designed surgical instrument provided with a marker enables tracking of an end of the surgical instrument in a case where image-guided surgery is executed (see, for example, Patent Document 1).

Furthermore, with a technology to combine the real world and the virtual world, such as augmented reality (AR) or mixed reality (MR), it is conceivable that interaction with the virtual world will be made using a real object. For example, it is conceivable that a user will execute surgery on a virtual human body using a surgical instrument that is a real object. In this case, a system that combines the real world and the virtual world needs to recognize and track a portion where the surgical instrument acts on the virtual human body (hereinafter, referred to as acting portion).

In response to this, for example, it is conceivable that the use of the specifically-designed surgical instrument disclosed in Patent Document 1 will enable the system to recognize and track the acting portion of the surgical instrument.

### CITATION LIST

### Patent Document

Patent Document 1: Japanese Translation of PCT International Application Publication No. 2017-535308

### SUMMARY OF THE INVENTION

### Problems to be Solved by the Invention

On the other hand, for example, it is conceivable that there will be a need to execute surgery on the virtual human body using any desired surgical instrument familiar to a surgeon, instead of such a specifically-designed surgical instrument.

The present technology has been made in view of such circumstances, and it is therefore an object of the present technology to enable easy recognition and tracking of a portion where a real object acts on its surroundings.

### Solutions to Problems

An information processing device according to one aspect of the present technology includes a recognition unit that recognizes a relative position of an acting portion relative to a marker fixed to a target object, the acting portion corresponding to a portion of the target object used by a user to act on surroundings in a virtual world or a real world, and a tracking unit that tracks the acting portion on the basis of the relative position of the acting portion relative to the marker.

An information processing method according to one aspect of the present technology includes recognizing a relative position of an acting portion relative to a marker fixed to a target object, the acting portion corresponding to a portion of the target object used by a user to act on surroundings in a virtual world or a real world, and tracking the acting portion on the basis of the relative position of the acting portion relative to the marker.

In one aspect of the present technology, a relative position of an acting portion relative to a marker fixed to a target object is recognized, the acting portion corresponding to a portion of the target object used by a user to act on surroundings in a virtual world or a real world, and the acting portion is tracked on the basis of the relative position of the acting portion relative to the marker.

### BRIEF DESCRIPTION OF DRAWINGS

FIG. 1 is a diagram for describing an overview of the present technology.

FIG. 2 is a diagram illustrating an example of an exterior configuration of an AR system to which the present technology is applied.

FIG. 3 is a block diagram illustrating an example of a functional configuration of the AR system to which the present technology is applied.

FIG. 4 is a diagram illustrating an example of an exterior configuration of a marker to which the present technology is applied.

FIG. 5 is a flowchart for describing acting portion registration processing.

FIG. 6 is a diagram for describing the acting portion registration processing.

FIG. 7 is a diagram for describing the acting portion registration processing.

FIG. 8 is an external view of a modification of the marker.

FIG. 9 is a diagram illustrating an example of the marker on a target object.

FIG. 10 is a diagram illustrating a modification of the marker.

FIG. 11 is a diagram for describing a modification of an acting portion registration method.

FIG. 12 is a diagram for describing a modification of the acting portion registration method.

FIG. 13 is a diagram for describing a modification of the acting portion registration method.

FIG. 14 is a diagram for describing an example of an acting portion shape registration method.

FIG. 15 is a diagram for describing an example of the acting portion shape registration method.

FIG. 16 is a diagram for describing an example of the acting portion shape registration method.

FIG. 17 is a diagram illustrating an example of a target object provided with a plurality of acting portions.

FIG. 18 is a diagram for describing an example of an acting portion function registration method.

FIG. 19 is a diagram for describing an example of the acting portion function registration method.

FIG. 20 is a diagram for describing an example of an acting portion action direction registration method.

FIG. 21 is a diagram for describing an example of an acting portion movement range registration method.

FIG. 22 is a diagram for describing a modification of the acting portion registration method.

FIG. 23 is a block diagram illustrating an example of a functional configuration of an information processing system to which the present technology is applied.

FIG. 24 is a diagram illustrating an example of an acting portion position.

FIG. 25 is a diagram illustrating an example of the acting portion position.

FIG. 26 is a block diagram illustrating an example of a configuration of a computer.

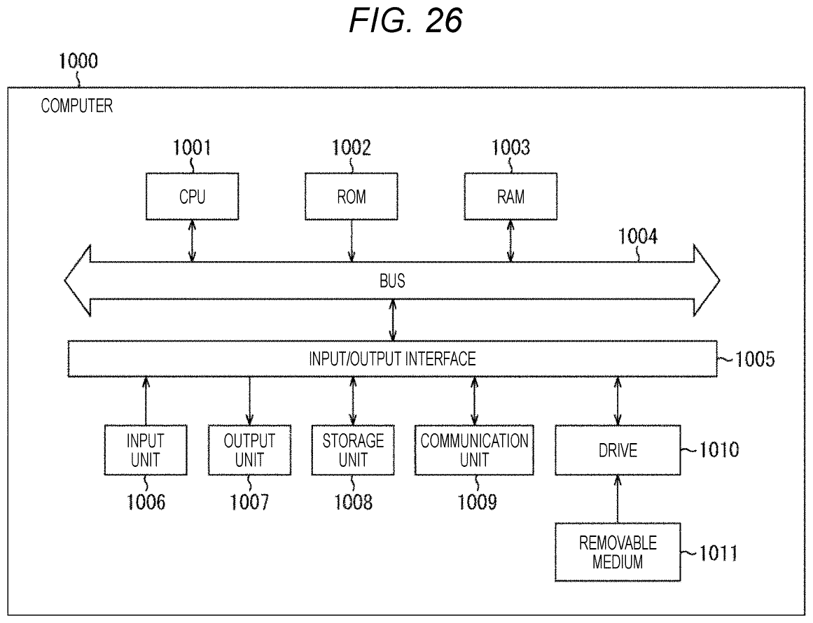

### MODE FOR CARRYING OUT THE INVENTION

Hereinafter, modes for carrying out the present technology will be described. The description will be given in the following order.
1. Overview of present technology
2. First embodiment
3. Modification of first embodiment
4. Second embodiment
5. Other modifications
6. Others

### 1. Overview of Present Technology

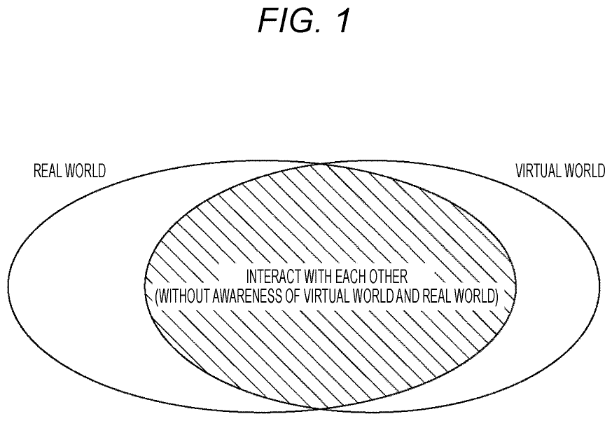

First, an overview of the present technology will be described with reference to FIG. 1.

As illustrated in FIG. 1, there is a possibility that a technology to combine the real world and the virtual world, such as AR or MR, will cause interaction between the real world and the virtual world without consciousness of the virtual world and the real world. That is, there is a possibility that the real world will trigger interaction with the virtual world, or the virtual world will trigger interaction with the real world.

In a case where the real world triggers interaction with the virtual world, for example, it is conceivable that a real object will be used to act on the virtual world (virtual object or virtual space). Specifically, for example, as described above, it is conceivable that a user will execute surgery on a virtual human body that is a virtual object using a surgical instrument that is a real object. For example, it is conceivable that the user will write a character in the virtual space using a pen that is a real object.

Therefore, in a case where a real object is used to act on the virtual world as described above, it is necessary for a system that combines the real world and the virtual world to recognize and track an acting portion where the real object acts on the virtual world.

In response to this, the present technology enables easy recognition and tracking of an acting portion where any real object acts on its surroundings in the virtual world or the real world.

Note that, herein, an object simply described as an object refers to a real object existing in the real world unless otherwise specified. On the other hand, an object existing in the virtual world is basically described as a virtual object so as to be distinguishable from the real object.

### 2. First Embodiment

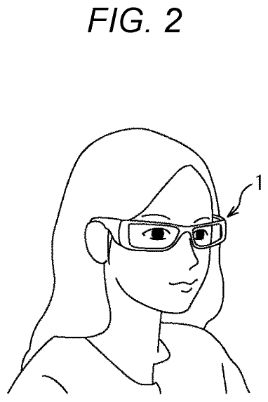

Next, a first embodiment of the present technology will be described with reference to FIGS. 2 to 7.

### <Configuration Example of AR System 1>

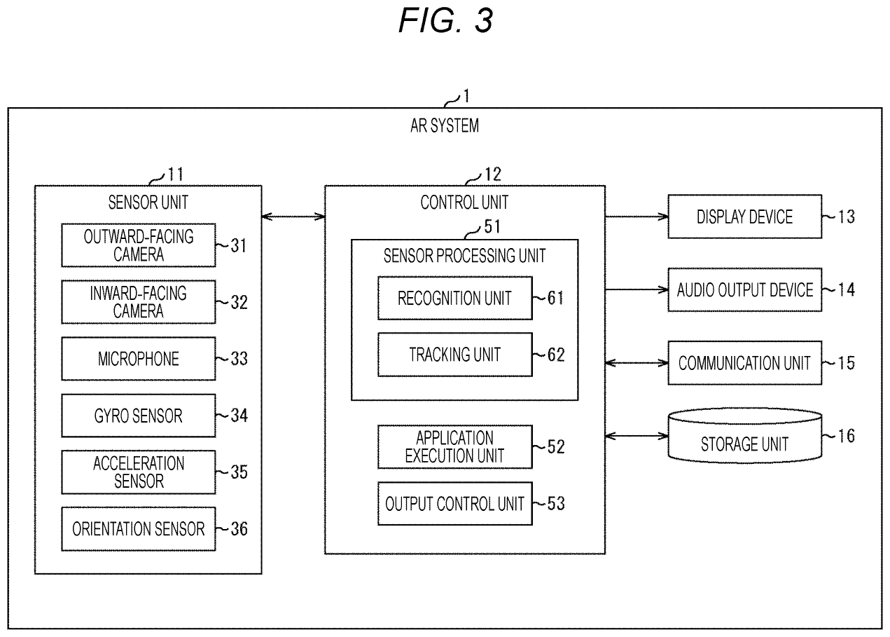

First, a configuration example of an augmented reality (AR) system 1 to which the present technology is applied will be described with reference to FIGS. 2 and 3. FIG. 2 illustrates an example of an exterior configuration of the AR system 1. FIG. 2 illustrates an example of a functional configuration of the AR system 1.

In this example, as illustrated in FIG. 2, the AR system 1 includes AR glasses serving as an eyeglass-type wearable system, and is used with being worn on the head of the user.

As illustrated in FIG. 3, the AR system 1 includes a sensor unit 11, a control unit 12, a display device 13, an audio output device 14, and a communication unit 15.

The sensor unit 11 includes a sensor group for detecting a surrounding environment of the AR system 1, a state of the user, and a state of the AR system 1. For example, the sensor unit 11 includes an outward-facing camera 31, an inward-facing camera 32, a microphone 33, a gyro sensor 34, an acceleration sensor 35, and an orientation sensor 36.

The outward-facing camera 31 captures an image of the surroundings of the AR system 1 (for example, user's line-of-sight direction). The outward-facing camera 31 supplies, to the control unit 12, data (hereinafter, referred to as surrounding image data) indicating a captured image (hereinafter, referred to as surrounding image) obtained by capturing the image of the surroundings of the AR system 1.

The inward-facing camera 32 captures an image of the user (for example, both eyes of the user and an area around the eyes). The inward-facing camera 32 supplies, to the control unit 12, data (hereinafter, referred to as user image data) indicating a captured image (hereinafter, referred to as user image) obtained by capturing the image of the user.

The microphone 33 collects ambient sounds around the AR system 1 and supplies audio data indicating the collected sounds to the control unit 12.

The gyro sensor 34 detects an angular velocity of the AR system 1 and supplies angular velocity data indicating the detection result to the control unit 12.

The acceleration sensor 35 detects acceleration of the AR system 1 and supplies acceleration data indicating the detection result to the control unit 12.

The orientation sensor 36 detects an orientation of the AR system 1 and supplies orientation data indicating the detection result to the control unit 12.

The control unit 12 includes a processor such as a central processing unit (CPU), and executes various processing of the AR system 1 and controls each unit of the AR system 1. The control unit 12 includes a sensor processing unit 51, an application execution unit 52, and an output control unit 53.

The sensor processing unit 51 processes data detected by the sensor unit 11. The sensor processing unit 51 includes a recognition unit 61 and a tracking unit 62.

The recognition unit 61 recognizes the surrounding environment of the AR system 1, the state of the user, the state of the AR system 1, a state of the virtual world, and the like on the basis of the data received from each sensor of the sensor unit 11 and information received from the output control unit 53.

For example, the recognition unit 61 executes processing of recognizing a surrounding object (real object) of the AR system 1 on the basis of the surrounding image data. For example, the recognition unit 61 recognizes a position, a shape, a type, a feature, a motion, and the like of the surrounding object. Examples of the object to be recognized by the recognition unit 61 includes an object used by the user to use the AR system 1 (hereinafter, referred to as target object) and a body part such as fingers of the user's hand.

For example, the recognition unit 61 executes processing of recognizing the state of the virtual world virtually displayed in the field of view of the user on the basis of the information received from the output control unit 53. For example, the recognition unit 61 recognizes a position, shape, type, feature, motion, and the like of an object in the virtual world (virtual object).

For example, the recognition unit 61 executes processing of recognizing a marker used to recognize an acting portion of the target object on the basis of the surrounding image data. For example, the recognition unit 61 recognizes a position, shape, feature, motion, and the like of the marker.

For example, the recognition unit 61 executes processing of recognizing the state of the user on the basis of the result of recognizing the surrounding object of the AR system 1 and the user image data. For example, the recognition unit 61 recognizes an action, line-of-sight direction, and the like of the user.

For example, the recognition unit 61 executes processing of recognizing the acting portion of the target object in the surrounding image on the basis of the result of recognizing the surrounding object of the AR system 1, the result of recognizing the state of the virtual world, and the result of recognizing the state of the user. For example, the recognition unit 61 recognizes a position, shape, function, and the like of the acting portion of the target object.

For example, the recognition unit 61 executes processing of registering the acting portion of the target object. Specifically, the recognition unit 61 executes the processing of recognizing the acting portion of the target object as described above, and stores, into a storage unit 16, information indicating the result of the recognition processing (for example, the position, shape, function, and the like of the acting portion of the target object).

The tracking unit 62 tracks the acting portion of the target object in the surrounding image on the basis of the result of recognizing the marker and the acting portion of the target object by the recognition unit 61.

The application execution unit 52 executes predetermined application processing on the basis of the data received from each sensor of the sensor unit 11, the result of recognizing the surrounding object of the AR system 1, the result of recognizing the state of the user, the result of recognizing the state of the virtual world, the result of recognizing the acting portion of the target object, and the like. For example, the application execution unit 52 executes application processing that acts on the virtual world using a real object.

The output control unit 53 controls image and audio output on the basis of the result of executing the application.

The display device 13 displays, under the control of the output control unit 53, an image (moving image or still image) superimposed on the real world in the field of view of the user.

The audio output device 14 includes, for example, at least one device capable of outputting audio, such as a speaker, headphones, or earphones. The audio output device 14 outputs audio under the control of the output control unit 53. The communication unit 15 communicates with an external device. Note that the communication method is not particularly limited.

The storage unit 16 stores data, programs, and the like necessary for the processing in the AR system 1.

### <Configuration Example of Marker 101>

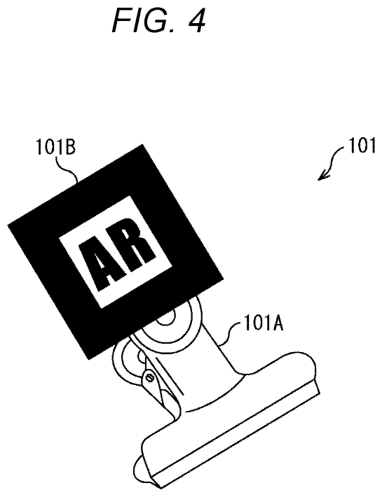

FIG. 4 illustrates an example of an exterior configuration a marker 101 detachably attached to the target object.

The marker 101 is a clip-type marker, and includes a clip portion 101A and a pattern portion 101B.

The clip portion 101A is a portion that holds the target object to attach the marker 101 to the target object and fix the position of the marker 101 relative to the target object.

The pattern portion 101B is a portion indicating a predetermined pattern (for example, an image, a character, or the like) for recognizing the marker 101. Note that the pattern of the pattern portion 101B is not particularly limited as long as the pattern can be recognized by the recognition unit 61 of the AR system 1.

Note that the form of the marker is not particularly limited to the clip type as long as the marker can be attached to the target object and fix its position relative to the target object.

### <Acting Portion Registration Processing>

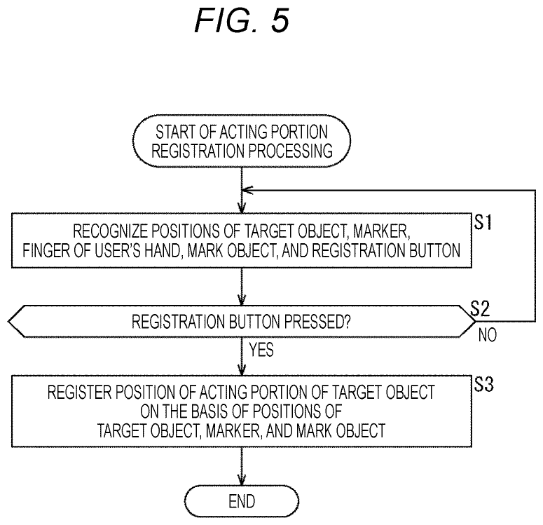

Next, acting portion registration processing executed by the AR system 1 will be described with reference to the flowchart in FIG. 5.

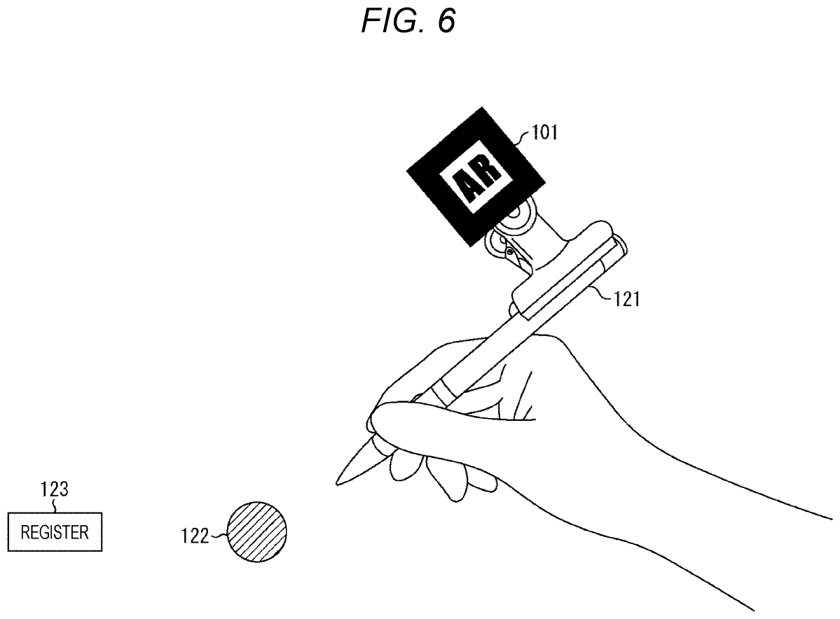

Hereinafter, a case where a tip (nib) of a pen 121 to which the marker 101 is attached as illustrated in FIG. 6 is registered as the acting portion will be described as a specific example.

Note that a mark object 122 and a registration button 123 in FIG. 6 are, for example, display items displayed in the virtual world. Specifically, for example, the mark object 122 and the registration button 123 are display items virtually displayed in the field of view of the user by the display device 13 under the control of the output control unit 53.

In step S1, the recognition unit 61 recognizes the positions of the target object, the marker, the fingers of the user's hand, the mark object, and the registration button.

Specifically, the recognition unit 61 executes object recognition processing on the basis of the surrounding image data supplied from the outward-facing camera 31, and recognizes positions of the pen 121, the marker 101, and the fingers of the user's hand in the real world.

Furthermore, the recognition unit 61 recognizes display positions of the mark object 122 and the registration button 123 in the field of view of the user on the basis of the information received from the output control unit 53. For example, the recognition unit 61 converts display positions of the mark object 122 and the registration button 123 in the virtual world into display positions of the mark object 122 and the registration button 123 in the real world.

In step S2, the recognition unit 61 determines whether or not the registration button has been pressed.

For example, in a case where the tip of the pen 121 is registered as the acting portion, the user virtually presses the registration button 123 with a finger of the user's hand with the tip of the pen 121 placed on top of the mark object 122 (region where the mark object 122 is virtually displayed) in the field of view of the user.

In response to this, the recognition unit 61 determines whether or not the registration button 123 has been virtually pressed by the finger of the user's hand on the basis of the result of recognizing the position of the finger of the user's hand and the display position of the registration button 123. In a case where it is determined that the registration button 123 has not been pressed, the processing returns to step S1.

Thereafter, step S1 and step S2 are repeatedly executed until it is determined in step S2 that the registration button 123 has been pressed.

On the other hand, in a case where it is determined in step S2 that the registration button 123 has been pressed, the processing proceeds to step S3.

In step S3, the recognition unit 61 registers the acting portion of the target object on the basis of the positions of the target object, the marker, and the mark object.

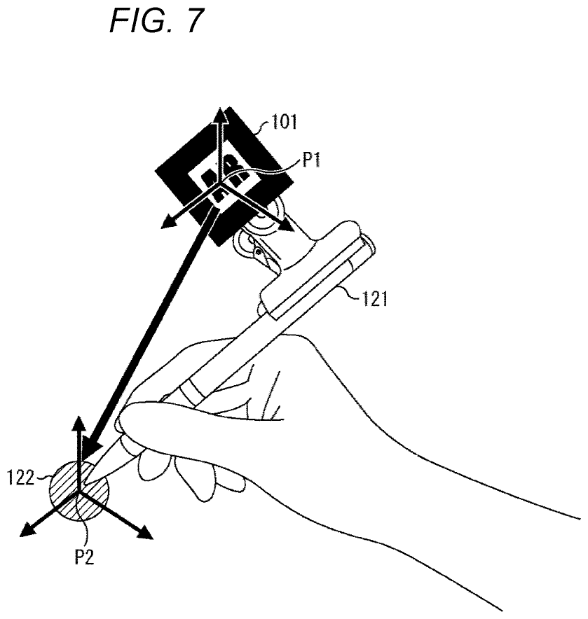

For example, as illustrated in FIG. 7, when the registration button 123 is pressed, the recognition unit 61 recognizes a portion P2 of the pen 121 (for example, the tip of pen 121) virtually placed on top of the mark object 122 as the acting portion of the pen 121. Then, the recognition unit 61 recognizes a relative position of the acting portion P2 relative to a reference point P1 of the marker 101. The recognition unit 61 stores, into the storage unit 16, information indicating the relative position of the acting portion P2 relative to the reference point P1 of the marker 101.

As a result, the position of the acting portion of the pen 121 is registered in the AR system 1. Then, the tracking unit 62 can track the acting portion of the pen 121 with reference to the marker 101 on the basis of the relative position of the acting portion of the pen 121 relative to the marker 101.

Thereafter, the acting portion registration processing ends.

As described above, for example, even if the acting portion of the target object is small or the feature of the acting portion is not clear, the recognition unit 61 can easily and reliably recognize the position of the acting portion of the target object. Furthermore, the tracking unit 62 can easily and accurately track the acting portion on the basis of the relative position of the acting portion of the target object relative to the marker.

As a result, for example, the user can easily interact with the virtual world using a familiar tool, a tool at hand, a tool desired to be used for practice, or the like without using a special tool. For example, it is possible to cut a virtual cut model with scissors familiar to a hairdresser, practice surgery on a virtual human body using a scalpel actually used by a surgeon, or write characters with virtual ink on a desk surface with a ballpoint pen that the user has at hand.

### 3. Modification of First Embodiment

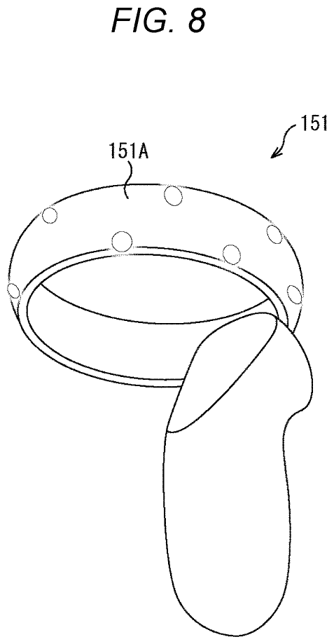

Next, a modification of the first embodiment of the present technology will be described with reference to FIGS. 8 to 22.

### <Modification Related to Marker>

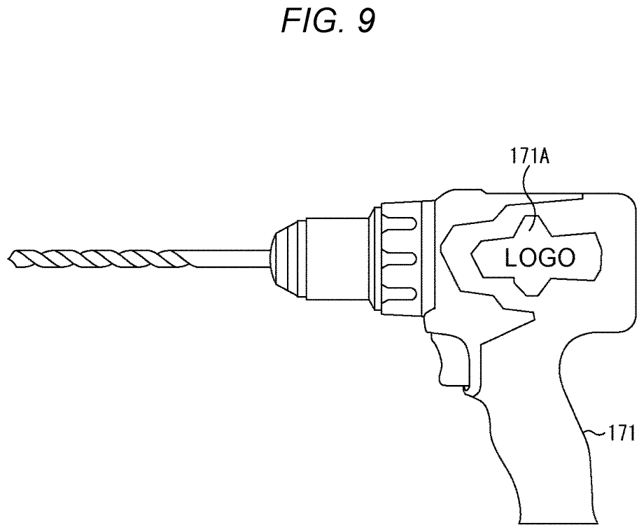

First, a modification of the marker will be described with reference to FIGS. 8 and 9.

For example, the marker need not necessarily have a pattern that is visible to the user. For example, as illustrated in FIG. 8, a marker 151 that displays a predetermined pattern in response to light other than visible light such as infrared light (IR) may be used.

Specifically, a light emitting unit that emits IR in a predetermined pattern is provided on a side surface 151A of a ring-shaped portion of the marker 151. For example, the recognition unit 61 recognizes the marker 151 on the basis of the light emission pattern of the marker 151.

For example, the recognition unit 61 may recognize a characteristic portion of the surface of the target object as a marker. Specifically, for example, in a case where a drill 171 in FIG. 9 is the target object, the recognition unit 61 may recognize a logo 171A displayed on a surface of the drill 171 as a marker. This eliminates the need for attaching a marker to the target object.

For example, the recognition unit 61 may recognize a three-dimensional shape of the target object as a marker. For example, the user may rotate the target object in front of the AR system 1 to cause the recognition unit 61 to recognize the three-dimensional shape of the target object. For example, the recognition unit 61 may acquire information regarding the three-dimensional shape of the target object from a website or the like regarding the target object using the communication unit 15. This allows the tracking unit 62 to track the marker regardless of how the user holds the target object.

### <Modification Regarding Method for Registering Acting Portion of Target Object>

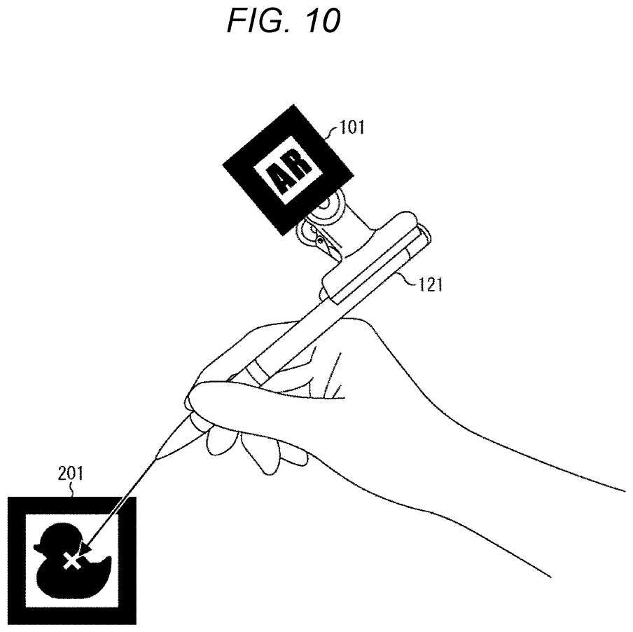

Next, a modification related to the method for registering the acting portion of the target object will be described with reference to FIGS. 10 to 22.

For example, at least one of the mark object 122 or the registration button 123 in FIG. 6 described above may be a display item displayed in the real world (for example, projected onto a desk, a wall, a floor, or the like). Then, the user may register the acting portion of the target object using the mark object 122 and the registration button 123 displayed in the real world.

Note that, in the following description, unless otherwise specified, the mark object and the registration button are virtually displayed in the field of view of the user. Furthermore, virtually placing the target object or the like on top of the display item (display item in the virtual world) virtually displayed in the field of view of the user will be simply described hereinafter as placing the target object or the like on top of the display item.

For example, as illustrated in FIG. 10, a marker 201 that is different in pattern from the marker 101 and can be recognized by the AR system 1 may be used as a mark object.

Note that the marker 201 may be displayed in the real world or the virtual world by the display device 13 under the control of the output control unit 53, or may be displayed or provided in the real world in advance.

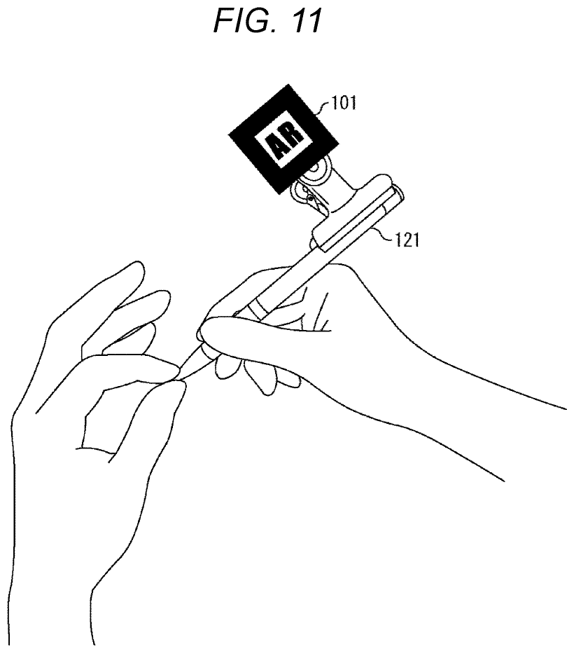

For example, if the recognition unit 61 can track the motion of the fingers of the user by executing hand tracking, a portion of the target object touched by the fingertips of the user through a predetermined action may be recognized as the acting portion. For example, as illustrated in FIG. 11, the recognition unit 61 may recognize the tip of the pen 121 as the acting portion when the user holds the tip of the pen 121 between his/her fingertips.

For example, although not illustrated, a part of a specific real object such as a desk whose position is known in advance by the AR system 1 may be used as a mark object.

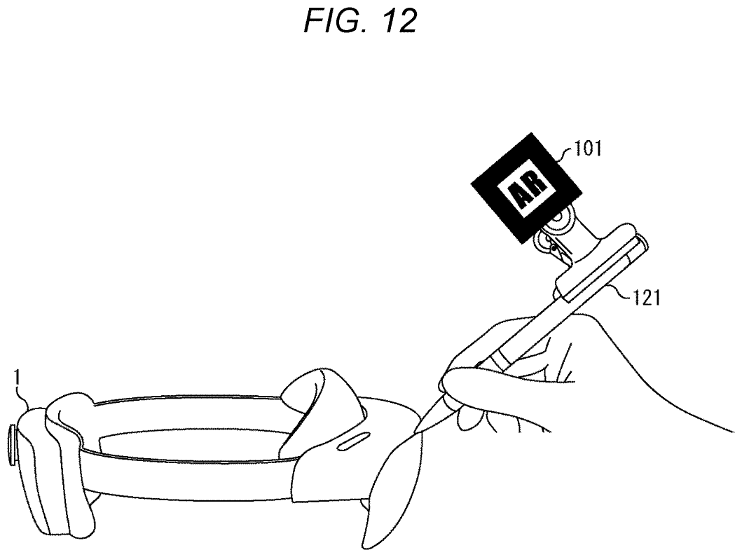

For example, a predetermined region on the AR system 1 may be used as a mark object. For example, as illustrated in FIG. 12, the tip of the pen 121 may be recognized as the acting portion by placing the tip of the pen 121 on top of a mark object provided in a predetermined region of a housing of the AR system 1.

In this case, the tip of the marker 101 is placed on top of the mark object on the housing of the AR system 1 with the marker 101 within the angle of view of the outward-facing camera 31. This allows the recognition unit 61 to recognize the position of the marker 101 on the basis of the surrounding image data. On the other hand, the recognition unit 61 knows in advance the position of the mark object, and the position of the mark object never moves on the AR system 1. Therefore, even if the mark object is not shown in the surrounding image, the recognition unit 61 can recognize the relative position of the mark object relative to the marker 101, and as a result, can recognize the relative position of the acting portion of the pen 121 relative to the marker 101.

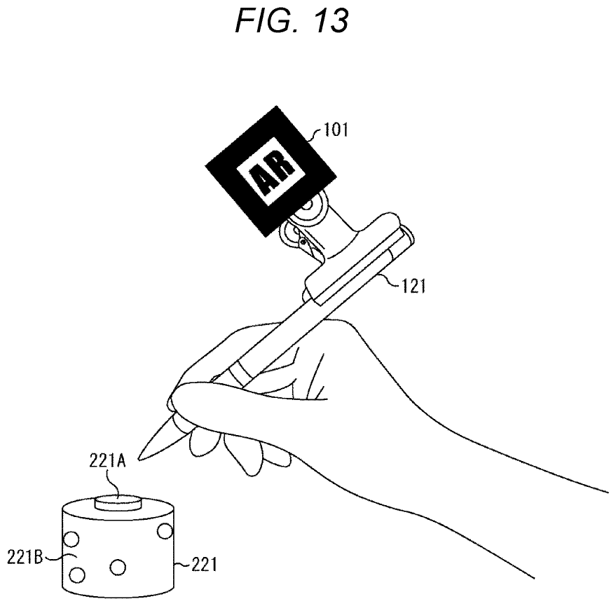

For example, as illustrated in FIG. 13, a specifically-designed real object may be used as a mark object 221. A switch 221A is provided on an upper surface of the mark object 221, and a marker 221B having a predetermined pattern is provided on a side surface of the mark object 221. The pattern of the marker 221B is registered in advance in the AR system 1, and the recognition unit 61 can recognize the mark object 221 on the basis of the marker 221B.

Then, for example, in a case where the user wants to register the tip of the pen 121 as the acting portion, the user presses the switch 221A of the mark object 221 with the tip of the pen 121.

In response to this, the recognition unit 61 recognizes that the switch 221A has been pressed by the tip of pen 121. When the switch 221A is pressed, the recognition unit 61 recognizes a portion of the pen 121 placed on top of the switch 221A (the tip of the pen 121) as the acting portion of the pen 121.

With this configuration, for example, the user can register the acting portion of the pen 121 only by pressing the switch 221A with the tip of the pen 121 without pressing the registration button.

Note that the nib, which is the acting portion of the pen 121 described above, has a point-like shape, but the shape of the acting portion of the target object is not necessarily limited to such a point-like shape. Possible examples of the shape of the acting portion of the target object include a linear shape, a planar shape, a three-dimensional shape, and the like.

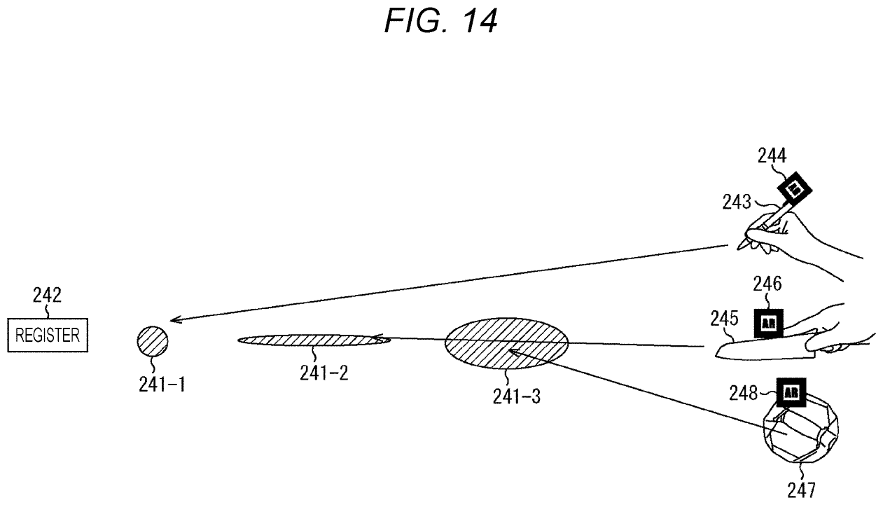

In response to this, for example, the display device 13 may display mark objects having different shapes representing the respective shapes of acting portions of target objects under the control of the output control unit 53. For example, in the example in FIG. 14, mark objects 241-1 to 241-3 and a registration button 242 are displayed.

The mark object 241-1 has a small circular shape. The mark object 241-1 is used to recognize, for example, a point-like acting portion such as a nib of a pen 243 with a marker 244.

The mark object 241-2 has an elongated shape. The mark object 241-2 is used to recognize, for example, a linear acting portion such as a blade of a knife 245 with a marker 246.

The mark object 241-3 has an elliptical shape larger than the mark object 241-1. The mark object 241-3 is used to recognize, for example, a planar acting portion such as a rubbing surface of a rubbing pad 247 with a marker 248.

Note that, in a case where it is not necessary to individually distinguish the mark objects 241-1 to 241-3, they are simply referred hereinafter to as mark objects 241.

For example, the user presses the registration button 242 with the acting portion of the target object placed on top of a mark object 241 suitable for the shape of the acting portion of the target object among the mark objects 241.

In response to this, the recognition unit 61 recognizes the shape of the acting portion of the target object on the basis of the shape of the mark object 241 on top of which the target object is placed.

This allows the user to interact with the virtual world using objects provided with acting portions having various shapes.

Furthermore, for example, the user may register an acting portion having a shape other than the point-like shape of the target object by moving the position where the acting portion is placed on top of the mark object.

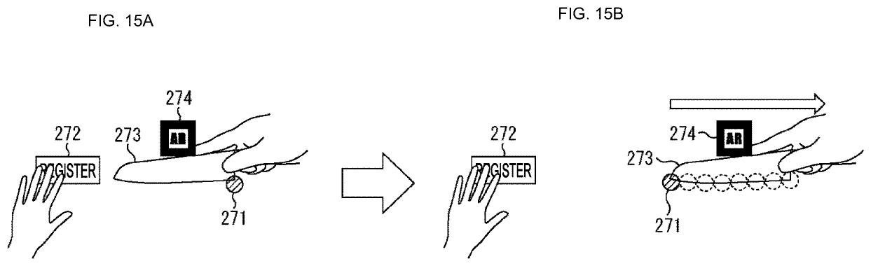

Specifically, for example, in the example in FIG. 15, a mark object 271 having a small circular shape and a registration button 272 are displayed.

For example, in a case where a blade of a knife 273 with a marker 274 is registered as the acting portion, as illustrated in A of FIG. 15, the user presses the registration button 272 with a position P11 of an end of the blade of the knife 273 placed on top of the mark object 271. Thereafter, as illustrated in B of FIG. 15, the user moves the position where the blade of the knife 273 is placed on top of the mark object 271 forward while pressing the registration button 272.

In response to this, the recognition unit 61 recognizes the whole of the blade of the knife 273 as the acting portion on the basis of a movement locus of the portion of the knife 273 placed on top of the mark object 271 while the registration button 272 is pressed.

Furthermore, for example, as described above with reference to FIG. 9, in a case where the user can register the acting portion of the target object by holding the acting portion between his/her fingers, the user can register an acting portion having a shape other than the point-like shape by moving the position where the acting portion of the target object is held between his/her fingers, for example.

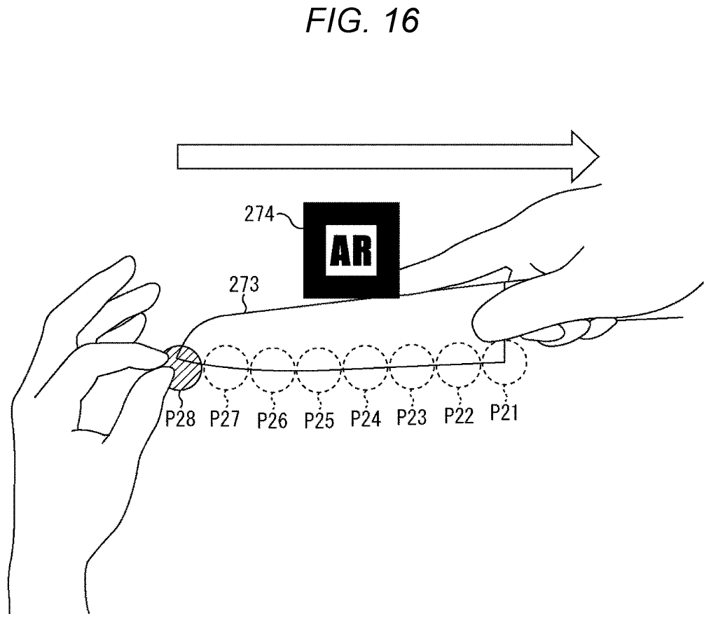

Specifically, for example, as illustrated in FIG. 16, after holding a position P21 of the end of the blade of the knife 273 with the marker 274, the user moves at least one of the knife 273 or his/her fingers to move the position where the blade of the knife 273 is held between the fingers of the user forward like a position P22 to a position P28.

In response to this, the recognition unit 61 recognizes the whole of the blade of the knife 273 as the acting portion on the basis of a movement locus of the portion of the knife 273 held between the fingers of the user.

Note that the user may register the acting portion of the target object by indicating a range of the acting portion through an action such as moving his/her finger along the acting portion, rather than holding the acting portion between his/her fingers.

Furthermore, for example, in a case where an acting portion of a target object obtained by assembling a plurality of parts each provided with an acting portion is registered, markers having different patterns are each attached to a corresponding one of the parts.

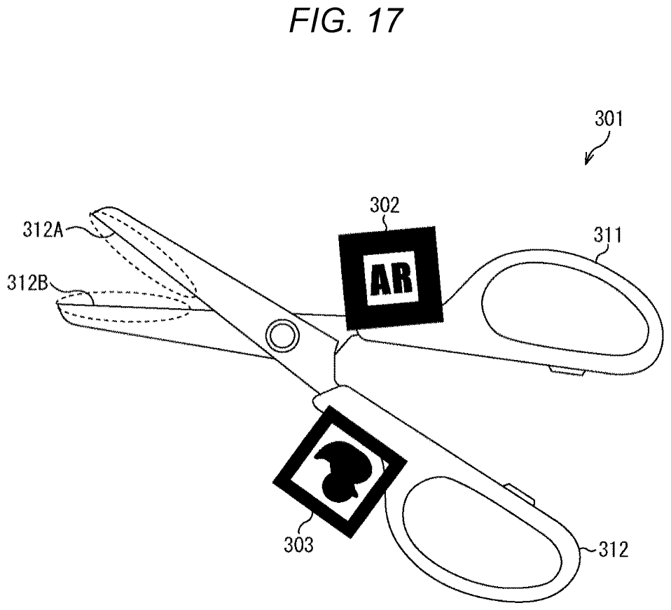

Specifically, scissors 301 in FIG. 17 corresponds to an object obtained by assembling a part 311 and a part 312. The part 311 includes an acting portion 311A that is a blade of the scissors 301 in a region enclosed by a dashed line. The part 312 includes an acting portion 312A that is a blade of the scissors 301 in a region enclosed by a dashed line.

In this case, a marker 302 is attached to the part 311. This causes the recognition unit 61 to recognize a relative position of the acting portion 311A of the part 311 relative to the marker 302.

Furthermore, a marker 303 different in pattern from the marker 302 is attached to the part 312. This causes the recognition unit 61 to recognize a relative position of the acting portion 312A of the part 312 relative to the marker 302.

Note that the above-described method is used as a method for registering the acting portion of each part.

Furthermore, for example, a function of the acting portion of the target object may be registered.

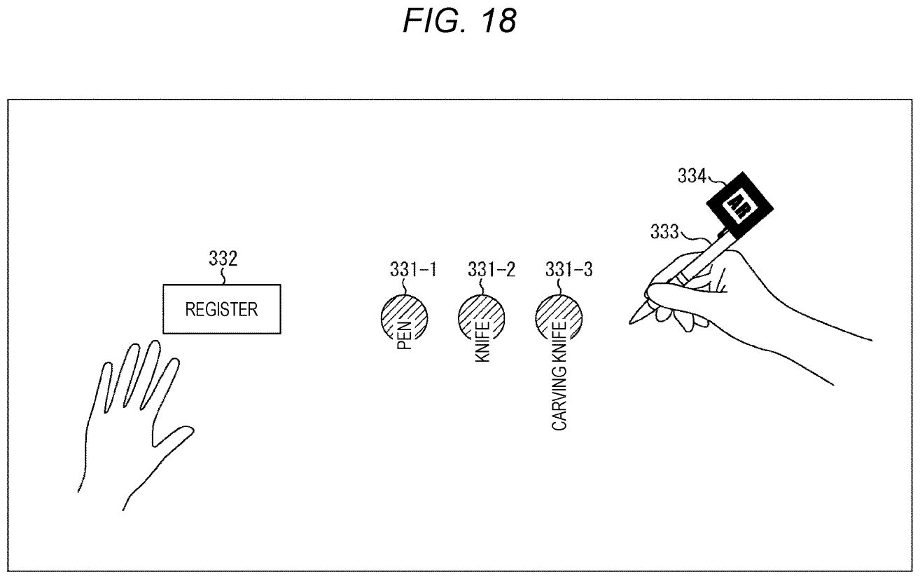

For example, as illustrated in FIG. 18, the display device 13 displays, under the control of the output control unit 53, a mark object 321-1 to a mark object 321-3 each indicating a corresponding function type together with a registration button 322.

The mark object 321-1 is labeled with a word “pen”. The mark object 321-1 is used to register both the position of the acting portion of the target object and the function of the acting portion as a pen.

The mark object 321-2 is labeled with a word “knife”. The mark object 321-2 is used to register both the position of the acting portion of the target object and the function of the acting portion as a knife.

The mark object 321-3 is labeled with a word “carving knife”. The mark object 321-3 is used to register both the position of the acting portion of the target object and the function of the acting portion as a carving knife.

For example, the user presses the registration button 322 with a tip of a pen 323 with a marker 324 placed on top of the mark object 321-1. This causes the recognition unit 61 to recognize both the relative position of the acting portion of the pen 323 relative to the marker 324 and the function of the acting portion as a pen.

Furthermore, for example, the position and function of the acting portion of the target object may be individually registered.

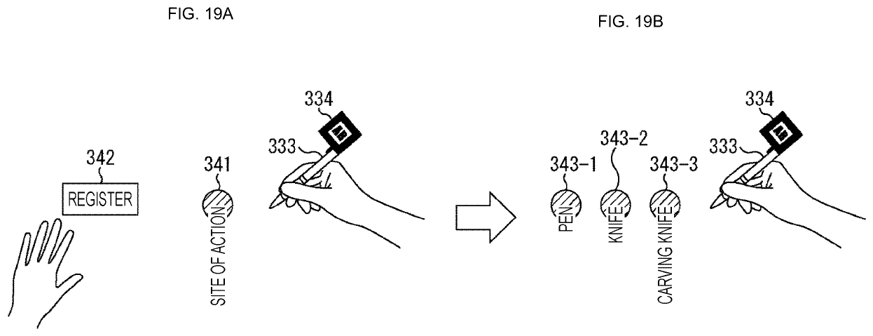

For example, the display device 13 first displays a mark object 341 and a registration button 342 as illustrated in A of FIG. 19 under the control of the output control unit 53.

The mark object 341 is labeled with a word “site of action”. The mark object 341 is used to register the position of the acting portion of the target object.

For example, the user presses the registration button 342 with the tip of the pen 323 with the marker 324 placed on top of the mark object 341. As a result, the relative position of the tip, which is the acting portion of the pen 323, relative to the marker 324 is registered by the above-described method.

Next, the display device 13 displays, under the control of the output control unit 53, a mark object 343-1 to a mark object 343-3 each indicating a corresponding function type as illustrated in B of FIG. 19.

The mark object 343-1 is labeled with a word “pen”. The mark object 343-1 is used to register the function of the acting portion as a pen.

The mark object 343-2 is labeled with a word “knife”. The mark object 343-2 is used to register the function of the acting portion as a knife.

The mark object 343-3 is labeled with a word “carving knife”. The mark object 321-3 is used to register the function of the acting portion as a carving knife.

For example, after registering the position of the acting portion of the pen 323, the user places the tip of the pen 323 on top of the mark object 343-1. This causes the recognition unit 61 to recognize the function of the acting portion of the pen 323 as a pen.

Note that, in the above description, an example where the same function as the original function of the acting portion of the target object is registered has been described. That is, an example where the function of the acting portion of the pen 321 is registered as a pen has been described.

On the other hand, for example, the user can register a function different from the original function for the acting portion of the target object by placing the acting portion of the target object on top of a mark object indicating the function different from the original function. For example, the user can register the function of the acting portion of the pen 321 as a knife.

With this configuration, for example, the user can use the acting portion of the target object as an acting portion having a function different from the original function in the virtual world.

Furthermore, in the above description, the mark object is labeled with the name of the corresponding tool such as pen, knife, or carving knife, or alternatively, may be labeled with a function type such as writing, cutting, or carving, for example.

Furthermore, for example, a direction in which the acting portion of the target object acts (hereinafter, referred to as action direction) may be registered.

Specifically, for example, it is conceivable that the function of a laser pointer will be assigned to a rod-shaped target object such as a pen in the virtual world. In this case, an emission direction of a laser beam, which is the action direction of the target object, is not determined only by registering the position of the acting portion of the target object.

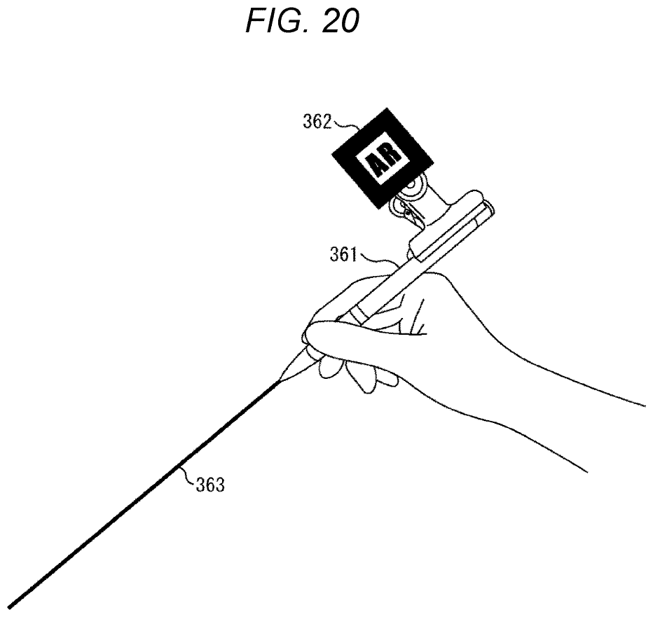

In response to this, for example, in a case where the position or function of the acting portion of the target object is registered, the action direction may be registered on the basis of the orientation of the target object or the like. For example, as illustrated in FIG. 20, a case where a laser beam 363 is emitted in parallel to an axial direction of a pen 361 with a marker 362 from a tip of the pen 361 in the virtual world will be described.

In this case, the tip of the pen 361 can be registered as the acting portion, and the function of the acting portion of the pen 361 can be registered as a laser pointer by the above-described method.

Then, for example, in order to register at least one of the position or function of the acting portion of the pen 361, the emission direction of the laser beam may be registered on the basis of the orientation of the pen 361 with the tip of the pen 361 placed on top of the mark object. For example, in a case where the user wants to emit the laser beam in parallel along the axis of the pen 361, the pen 361 is vertically placed on top of the mark object.

In response to this, the recognition unit 61 recognizes, on the basis the orientation of the pen 361 relative to the mark object, the emission direction of the laser beam, which is the action direction of the pen 361, as a direction parallel to the axial direction of the pen 361.

Furthermore, for example, in a case where the relative position of the acting portion relative to the marker changes as the target object deforms to move the acting portion, even with the relative position of the acting portion relative to the marker registered by the above-described method, there is a possibility that the tracking unit 62 fails to track the acting portion due to the deformation of the target object.

In response to this, the acting portion of the target object may be registered with a wider range in accordance with a movement range of the acting portion.

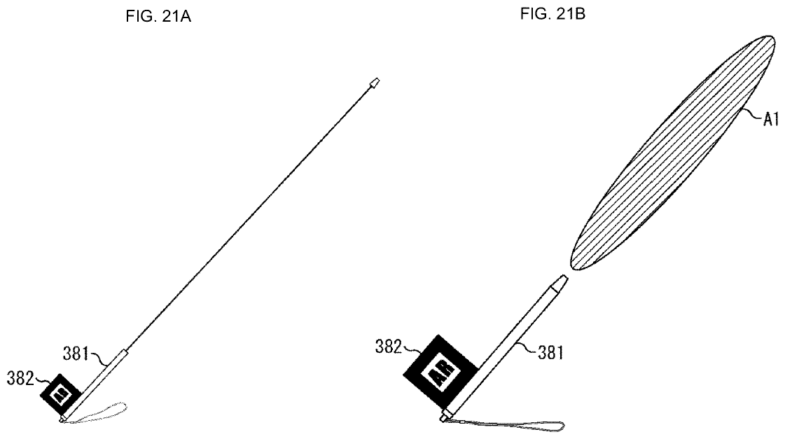

Specifically, as a pointing stick 381 illustrated in A and B of FIG. 21 extends and contracts, the position of an acting portion located at a distal end moves. Therefore, a relative position of the acting portion relative to a marker 382 changes as the pointing stick 381 extends and contracts.

Note that A of FIG. 21 illustrates a state where the pointing stick 381 is extended. B of FIG. 21 illustrates a state where the pointing stick 381 is contracted.

Therefore, for example, as illustrated in B of FIG. 21, the recognition unit 61 may recognize a range A1 extending in the axial direction of the pointing stick 381 from the distal end of the pointing stick 381 in the contracted state as a range of the acting portion of the pointing stick 381.

Then, for example, information serving as a hint may be provided to the AR system 1, and the tracking unit 62 may automatically detect and track the distal end of the pointing stick 381 by machine learning or the like.

Furthermore, it is possible to register the acting portion of the target object using a surface already recognized by the recognition unit 61 (for example, a desk surface or the like) without using the mark object, for example.

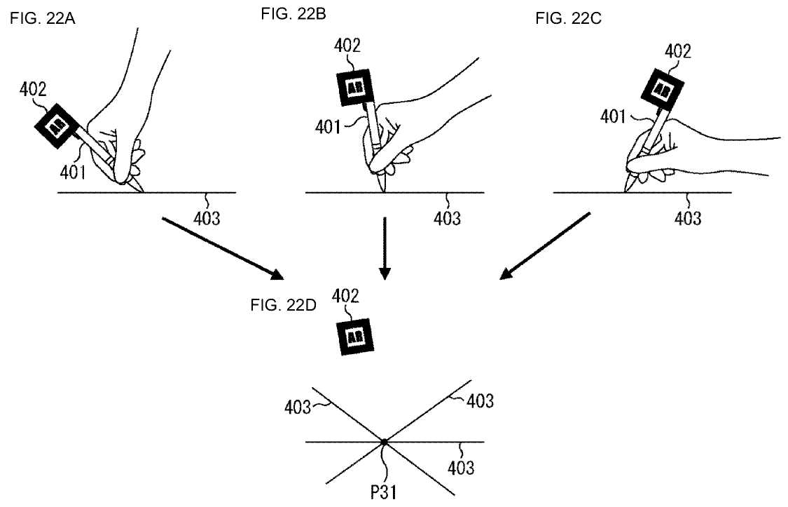

Specifically, as illustrated in FIG. 22, the user changes the orientation of a pen 401 with a marker 402 with the tip of the pen 401 in contact with a surface 403 already recognized by the recognition unit 61. In this example, as illustrated in A to C of FIG. 22, the orientation of the pen 401 is changed to three patterns.

In response to this, the recognition unit 61 recognizes a point P31 at which the pen 401 is in contact with the surface 403 as the acting portion of the pen 401 on the basis of a positional relationship between the surface 403 and the marker 402 for each orientation.

Note that, for example, the recognition unit 61 can recognize, by a similar method, a linear acting portion of the target object on the basis of a change in the orientation of the target object relative to the already-recognized surface, or can recognize a point-like acting portion of the target object on the basis of a change in the orientation of the target object relative to the already-recognized line segment.

Furthermore, for example, after registering at least one of the position, function, or shape of the acting portion of a certain target object, the recognition unit 61 may apply at least one of the position, function, or shape of the acting portion of the target object previously registered to a target object of the same type by default.

Here, the target object of the same type is an object in which the shape of the target object and the position of the acting portion are the same. For example, pens having the same shape but different colors are target objects of the same type.

Note that in a case where a detachable marker is used, even the target object of the same type suffers a change in the relative position of the acting portion relative to the marker due to a difference in the attachment position of the marker. It may therefore be required to make an adjustment to a position of an acting portion of a new target object after applying the position of the acting portion of the target object previously registered to the position of the acting portion of the new target object.

### 4. Second Embodiment

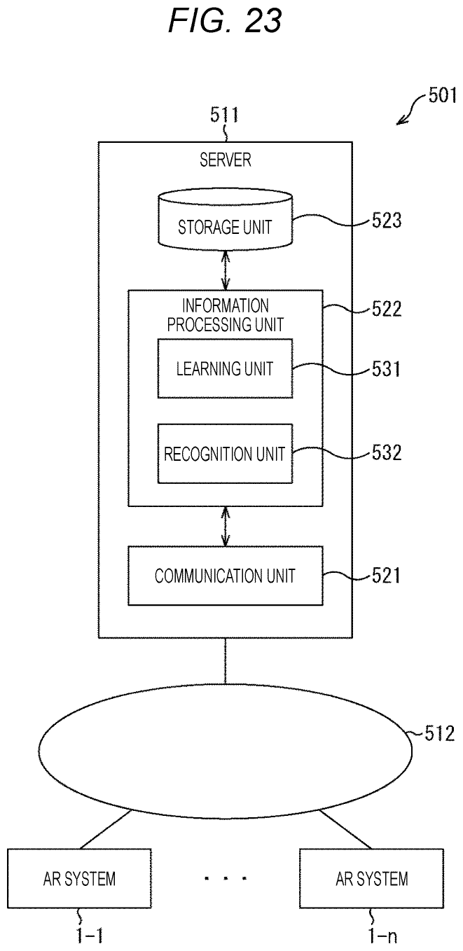

Next, a second embodiment of the present technology will be described with reference to FIG. 23.

In the second embodiment, a server 511 provides, to the AR system 1, information regarding the acting portion of the target object.

Specifically, FIG. 23 illustrates an example of a configuration of an information processing system 501 to which the present technology is applied.

The information processing system 501 includes AR systems 1-1 to 1-n and the server 511. The AR systems 1-1 to 1-n and the server 511 are connected to each other via a network 512. The server 511 includes a communication unit 521, an information processing unit 522, and a storage unit 523. The information processing unit 522 includes a recognition unit 531 and a learning unit 532.

Note that, in a case where it is not necessary to individually distinguish the AR systems 1-1 to 1-n, they are simply referred hereinafter to as AR system 1.

The communication unit 521 communicates with each AR system 1 via the network 512.

The recognition unit 531 recognizes the acting portion of the target object used by the user of the AR system 1 on the basis of information received from the AR system 1 and object information regarding each object stored in the storage unit 523. The recognition unit 531 transmits the information regarding the recognized acting portion of the target object to the AR system 1 via the communication unit 521 and the network 512.

The learning unit 532 learns the information regarding the acting portion of each object on the basis of the information collected from each AR system 1. The learning unit 532 stores the information regarding the acting portion of each object in the storage unit 523.

The storage unit 523 stores the object information regarding each object and the like. The object information includes, for example, information regarding the acting portion of each object, three-dimensional shape data of each object, image data of each object, and the like. Furthermore, the object information includes, for example, information provided from a manufacturer of each object or the like, information obtained by learning processing in the learning unit 532, and the like.

Here, an example of how to use the server 511 will be described.

For example, the recognition unit 61 of the AR system 1 executes the object recognition processing on a target object held by the user with his/her hand. The recognition unit 61 transmits target object information indicating the result of the object recognition processing to the server 511 via the network 512.

The target object information includes, for example, information that can be used to recognize the acting portion of the target object. For example, the target object information includes information indicating a feature of the target object, information indicating a shape of the user's hand holding the target object, information regarding a surrounding environment of the target object, and the like.

The recognition unit 531 specifically identifies the target object on the basis of the target object information and the object information stored in the storage unit 523, and recognizes the position, shape, function, and the like of the acting portion of the target object. The recognition unit 531 transmits acting portion information regarding the recognized acting portion of the target object to the AR system 1 via the communication unit 521 and the network 512.

Note that the acting portion information may include, for example, marker information available for tracking the acting portion such as image data or three-dimensional shape data of the target object.

With this configuration, the AR system 1 can recognize the position, function, shape, and the like of the acting portion of the target object on the basis of the information provided from the server 511 even without the registration operation executed by the user using a mark object or the like.

Furthermore, for example, in a case where each AR system 1 recognizes the acting portion of the target object by the above-described method, the AR system 1 transmits acting portion information regarding the recognized acting portion of the target object to the server 511 via the network 512.

Note that the acting portion information includes, for example, image data of the target object and the result the recognition of the acting portion of the target object (for example, the position, function, shape, and the like of the acting portion).

The learning unit 532 receives the acting portion information transmitted from each AR system 1 via the communication unit 521. The learning unit 532 learns the position, function, shape, and the like of the acting portion of each object on the basis of the acting portion information received from each AR system 1. The learning unit 532 updates the object information stored in the storage unit 523 on the basis of the information obtained as a result of the learning.

This allows the recognition unit 531 to recognize, on the basis of the information regarding the acting portion of the target object recognized by the AR system 1, the acting portion of a similar object.

Note that, for example, the learning unit 532 may train a recognizer that recognizes the acting portion of the target object using the target object information, and the recognition unit 531 may recognize, using the trained recognizer, the acting portion of the target object on the basis of the target object information.

Specifically, for example, the learning unit 532 trains the recognizer that recognizes the acting portion of the target object using the target object information by machine learning using training data including the information regarding the target object and learning data including ground truth data that includes the information regarding the acting portion of the target object.

Specifically, the training data includes information similar to the target object information provided from the AR system 1 at the time of recognizing the acting portion of the target object. For example, the training data includes at least information indicating the feature of the target object. Furthermore, the training data may include, for example, the shape of the user's hand holding the target object, the information regarding the surrounding environment of the target object, and the like.

The ground truth data includes, for example, information indicating at least the position and shape of the acting portion of the target object. Furthermore, the ground truth data may include information indicating the function of the acting portion of the target object.

A machine learning method is not particularly limited.

Then, the learning unit 532 trains a recognizer that recognizes at least the position and shape of the acting portion of the target object and recognizes, as necessary, the function of the acting portion of the target object on the basis of the target object information provided from the AR system 1.

The recognition unit 531 recognizes at least the position and shape of the acting portion of the target object and recognizes, as necessary, the function of the acting portion of the target object using the recognizer generated by the learning unit 532 on the basis of the target object information provided from the AR system 1.

With this configuration, for example, the recognition unit 531 can recognize, with higher recognition accuracy, an acting portion of a new target object that does not exist in the target object information stored in the storage unit 523.

### 5. Other Modifications

Next, modifications other than the above-described modification will be described.

For example, it is assumed that the acting portion of the target object is located at the end of the target object in many cases, but is not necessarily located at the end.

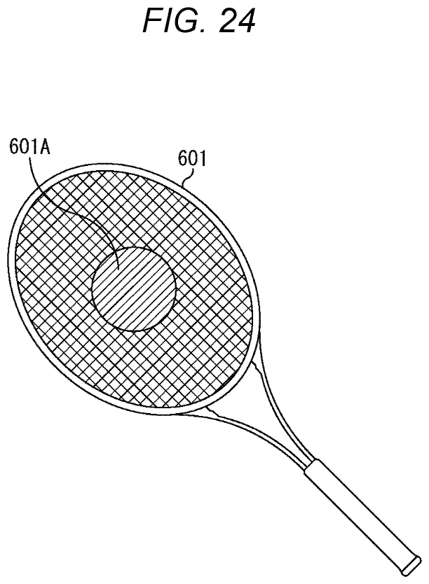

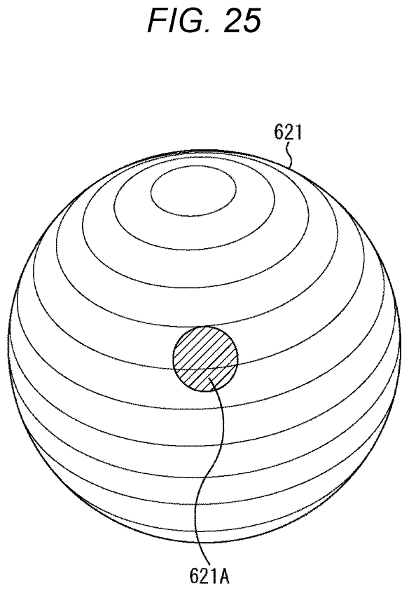

For example, as illustrated in FIG. 24, a circular region at the center of a face of a racket 601 is assumed to be registered as an acting portion 601A. For example, as illustrated in FIG. 25, a spherical region that is the center of gravity of a ball 621 is assumed to be registered as an acting portion 621A.

In this case, for example, information regarding the acting portion 601A of the racket 601 or the acting portion 621A of the ball 621 is used in, for example, determination of a collision between the acting portion 601A or the acting portion 621A and a virtual object.

For example, the target object of the present technology includes a body part of the user, and a part of the body of the user can be used as the acting portion. For example, the tip of the index finger or the palm of the user can be registered as the acting portion by the above-described method.

For example, the recognition unit 61 may recognize the acting portion of the target object in a case where the user executes a predetermined operation other than the press of the registration button. For example, the recognition unit 61 may recognize the acting portion of the target object when the predetermined operation is executed by means of a gesture or a voice. For example, the recognition unit 61 may recognize the acting portion of the target object in a case where a state where a part of the target object is placed on top of the mark object continues for at least a predetermined period of time.

The present technology is further applicable to AR systems other than AR glasses or MR systems. That is, the present technology is applicable to any systems capable of interacting with the virtual world using a real object.

The present technology is further applicable to a case where interaction with the real world is made using a real object. For example, the present technology is applicable to a case where the acting portion of the target object is recognized in a case where a picture or a character is drawn in an image displayed in the real world by a projector, a display, an electronic blackboard, or the like using the target object such as a pen.

For example, a transmitter such as an ultrasonic transmitter or an electromagnetic transmitter may be used as the marker. In this case, for example, the recognition unit 61 can recognize the position of the marker without using the surrounding image, and the tracking unit 62 can track the acting portion of the target object without using the surrounding image.

### 6. Others

### <Configuration Example of Computer>

The above-described series of processing can be executed by hardware and can also be executed by software. In a case where the series of processing is executed by software, a program constituting the software is installed in a computer. Here, examples of the computer include a computer incorporated in dedicated hardware, and for example, a general-purpose personal computer that can execute various functions by installing various programs.

FIG. 11 is a block diagram illustrating a configuration example of the hardware of the computer that executes the above-described series of processing with a program.

In a computer 1000, a central processing unit (CPU) 1001, a read only memory (ROM) 1002, and a random access memory (RAM) 1003 are interconnected by a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 includes an input switch, a button, a microphone, an imaging element, or the like. The output unit 1007 includes a display, a speaker, or the like. The storage unit 1008 includes a hard disk, a non-volatile memory, or the like. The communication unit 1009 includes a network interface or the like. The drive 1010 drives a removable medium 1011 such as a magnetic disk, an optical disc, a magneto-optical disk, or a semiconductor memory.

In the computer 1000 configured as described above, the series of processing described above is executed, for example, by the CPU 1001 loading a program stored in the storage unit 1008 into the RAM 1003 via the input/output interface 1005 and the bus 1004, and executing the program.

The program executed by the computer 1000 (CPU 1001) can be provided, for example, by being recorded in the removable medium 1011 as a package medium and the like. Furthermore, the program can be provided via a wired or wireless transmission medium such as a local area network, the Internet, or digital satellite broadcasting.

In the computer 1000, the program can be installed in the storage unit 1008 via the input/output interface 1005 by mounting the removable medium 1011 on the drive 1010. Furthermore, the program can be received by the communication unit 1009 via a wired or wireless transmission medium and installed in the storage unit 1008. Alternatively, the program can be installed in the ROM 1002 or the storage unit 1008 in advance.

Note that, the program to be executed by the computer may be a program by which processing is executed in time series in the order described herein, or may be a program by which processing is executed in parallel or at a required time such as when a call is made.

Furthermore, herein, a system means a set of a plurality of components (devices, modules (parts), and the like), and it does not matter whether or not all the components are in the same housing. Therefore, a plurality of devices housed in separate housings and connected to each other via a network and one device in which a plurality of modules is housed in one housing are both systems.

Moreover, the embodiment of the present technology is not limited to the above-described embodiments, and various modifications can be made without departing from the gist of the present technology.

For example, the present technology is applicable to a configuration adapted to cloud computing in which one function is shared and executed by a plurality of devices in cooperation via a network.

Furthermore, each step described with reference to the flowchart described above can be executed by one device, or can be executed by a plurality of devices in a shared manner.

Moreover, in a case where a plurality of pieces of processing is included in one step, the plurality of pieces of processing included in the one step can be executed by one device or executed by a plurality of devices in a shared manner.

### Example of Configuration Combination

The present technology may also have the following configurations.

(1)

An information processing device including:
a recognition unit that recognizes a relative position of an acting portion relative to a marker fixed to a target object, the acting portion corresponding to a portion of the target object used by a user to act on surroundings in a virtual world or a real world; and
a tracking unit that tracks the acting portion on the basis of the relative position of the acting portion relative to the marker.
   (2)

The information processing device according to the above (1), in which
the recognition unit recognizes a portion of the target object placed on top of a predetermined region as the acting portion.
   (3)

The information processing device according to the above (2), in which
the region corresponds to a region where a predetermined display item is virtually displayed in a field of view of the user or a region where the predetermined display item is displayed in the real world.
   (4)

The information processing device according to the above (3), in which
the recognition unit recognizes a shape of the acting portion on the basis of a shape of the display item on top of which the acting portion is placed among a plurality of the display items.
   (5)

The information processing device according to the above (3) or (4), in which
the recognition unit recognizes a shape of the acting portion on the basis of a movement locus of a portion where the target object is placed on top of the display item.
   (6)

The information processing device according to any one of the above (3) to (5), in which
the recognition unit recognizes a function of the acting portion on the basis of the display item on top of which the acting portion is placed among a plurality of the display items each displayed for a corresponding function type of the acting portion.
   (7)

The information processing device according to any one of the above (3) to (6), further including
an output control unit that controls display of the display item.
   (8)

The information processing device according to any one of the above (2) to (7), in which
the recognition unit recognizes, as the acting portion, a portion of the target object that is placed on top of the region when a predetermined operation is executed by the user.
   (9)

The information processing device according to any one of the above (2) to (8), in which
the recognition unit recognizes a direction in which the acting portion acts on the basis of an orientation with which the target object is placed on top of the region.
   (10)

The information processing device according to any one of the above (2) to (9), in which
the region corresponds to a region on an object different from the target object.
   (11)

The information processing device according to any one of the above (1) to (10), in which
the recognition unit recognizes, as the recognition unit, a portion of the target object touched by the user through a predetermined action.
   (12)

The information processing device according to the above (11), in which
the recognition unit recognizes a shape of the acting portion on the basis of a movement locus of the portion of the target object touched by the user through the predetermined action.
   (13)

The information processing device according to any one of the above (1) to (12), in which
the recognition unit recognizes, in a case where an orientation of the target object relative to a predetermined surface or a predetermined line changes with the acting portion placed on top of the surface or the line, the acting portion on the basis of a positional relationship between the marker and the surface or the line.
   (14)

The information processing device according to any one of the above (1) to (13), in which
the marker is detachably attached to the target object.
   (15)

The information processing device according to any one of the above (1) to (14), in which
the recognition unit recognizes a characteristic portion or three-dimensional shape of the target object as the marker.
   (16)

The information processing device according to any one of the above (1) to (15), in which
the recognition unit recognizes the relative position of the acting portion relative to the marker in a captured image obtained by capturing an image of the target object, and
the tracking unit tracks the acting portion in the captured image.
   (17)

The information processing device according to any one of the above (1) to (16), in which
the recognition unit executes object recognition processing on the target object, and recognizes the relative position of the acting portion relative to the marker on the basis of information indicating a result of the object recognition processing and on the basis of information provided from another information processing device.
   (18)

The information processing device according to any one of the above (1) to (17), in which
the acting portion corresponds to a portion that acts on a virtual object displayed virtually in a field of view of the user.
   (19)

The information processing device according to any one of the above (1) to (18), in which
the acting portion corresponds to a part of a body of the user.
   (20)

An information processing method including:
recognizing a relative position of an acting portion relative to a marker fixed to a target object, the acting portion corresponding to a portion of the target object used by a user to act on surroundings in a virtual world or a real world; and
tracking the acting portion on the basis of the relative position of the acting portion relative to the marker.

Note that the effects described herein are merely examples and are not limited, and other effects may be provided.

### REFERENCE SIGNS LIST

1 AR system
11 Sensor unit
12 Control unit
13 Display device
31 Outward-facing camera
51 Sensor processing unit
52 Application execution unit
53 Output control unit
61 Recognition unit
62 Tracking unit
101 Marker
501 Information processing system
511 Server
522 Information processing unit
531 Recognition unit
532 Learning unit

1. An information processing device comprising:
a recognition unit that recognizes a relative position of an acting portion relative to a marker fixed to a target object, the acting portion corresponding to a portion of the target object used by a user to act on surroundings in a virtual world or a real world; and
a tracking unit that tracks the acting portion on a basis of the relative position of the acting portion relative to the marker.

2. The information processing device according to claim 1, wherein
the recognition unit recognizes a portion of the target object placed on top of a predetermined region as the acting portion.

3. The information processing device according to claim 2, wherein
the region corresponds to a region where a predetermined display item is virtually displayed in a field of view of the user or a region where the predetermined display item is displayed in the real world.

4. The information processing device according to claim 3, wherein
the recognition unit recognizes a shape of the acting portion on a basis of a shape of the display item on top of which the acting portion is placed among a plurality of the display items.

5. The information processing device according to claim 3, wherein
the recognition unit recognizes a shape of the acting portion on a basis of a movement locus of a portion where the target object is placed on top of the display item.

6. The information processing device according to claim 3, wherein
the recognition unit recognizes a function of the acting portion on a basis of the display item on top of which the acting portion is placed among a plurality of the display items each displayed for a corresponding function type of the acting portion.

7. The information processing device according to claim 3, further comprising
an output control unit that controls display of the display item.

8. The information processing device according to claim 2, wherein
the recognition unit recognizes, as the acting portion, a portion of the target object that is placed on top of the region when a predetermined operation is executed by the user.

9. The information processing device according to claim 2, wherein
the recognition unit recognizes a direction in which the acting portion acts on a basis of an orientation with which the target object is placed on top of the region.

10. The information processing device according to claim 2, wherein
the region corresponds to a region on an object different from the target object.

11. The information processing device according to claim 1, wherein
the recognition unit recognizes, as the recognition unit, a portion of the target object touched by the user through a predetermined action.

12. The information processing device according to claim 11, wherein
the recognition unit recognizes a shape of the acting portion on a basis of a movement locus of the portion of the target object touched by the user through the predetermined action.

13. The information processing device according to claim 1, wherein
the recognition unit recognizes, in a case where an orientation of the target object relative to a predetermined surface or a predetermined line changes with the acting portion placed on top of the surface or the line, the acting portion on a basis of a positional relationship between the marker and the surface or the line.

14. The information processing device according to claim 1, wherein
the marker is detachably attached to the target object.

15. The information processing device according to claim 1, wherein
the recognition unit recognizes a characteristic portion or three-dimensional shape of the target object as the marker.

16. The information processing device according to claim 1, wherein
the recognition unit recognizes the relative position of the acting portion relative to the marker in a captured image obtained by capturing an image of the target object, and
the tracking unit tracks the acting portion in the captured image.

17. The information processing device according to claim 1, wherein
the recognition unit executes object recognition processing on the target object, and recognizes the relative position of the acting portion relative to the marker on a basis of information indicating a result of the object recognition processing and on a basis of information provided from another information processing device.

18. The information processing device according to claim 1, wherein
the acting portion corresponds to a portion that acts on a virtual object displayed virtually in a field of view of the user.

19. The information processing device according to claim 1, wherein
the acting portion corresponds to a part of a body of the user.

20. An information processing method comprising:
recognizing a relative position of an acting portion relative to a marker fixed to a target object, the acting portion corresponding to a portion of the target object used by a user to act on surroundings in a virtual world or a real world; and
tracking the acting portion on a basis of the relative position of the acting portion relative to the marker.
